(19) United States
(12) Patent Application Publication
(10) Pub. No.: US 2007/0223694 A1
(43) Pub. Date: Sep. 27, 2007

(54) Methods, media, and systems for entitlement clearing

(76) Inventor: David P. Krzemienski, Hoboken, NJ (US)

Correspondence Address: WILMER CUTLER PICKERING HALE AND DORR LLP, 399 PARK AVENUE, NEW YORK, NY, 10022, US

(21) Appl. No.: 11/726,329

(22) Filed: Mar. 21, 2007

Related U.S. Application Data
(60) Provisional application No. 60/784,320, filed on Mar. 21, 2006.

(51) Int. Cl. H04N 7/167

(52) U.S. Cl. 380/229

(57) ABSTRACT

In accordance with the disclosed subject matter, methods, media, and systems for entitlement clearing are provided. In some embodiments, media for entitlement clearing are provided including receiving a first entitlement request from a first vendor and a second entitlement request from a second vendor, determining the status of the first entitlement request and the status of the second entitlement request, and sending a first entitlement response to the first vendor and a second entitlement response to the second vendor.

### CROSS REFERENCE TO RELATED APPLICATION

This application claims the benefit of U.S. Provisional Patent Application No. 60/784,320, filed Mar. 21, 2006, which is hereby incorporated by reference herein in its entirety.

### TECHNICAL FIELD

The disclosed subject matter relates to methods, media, and systems for entitlement clearing.

### BACKGROUND

From the time the brokerage community (which are examples of “publishers”) began distributing content (e.g. research reports, economic analysis, corporate recommendations and financial estimates, etc.) to their clients through third parties (which are examples of “vendors”), the concept of entitlements existed. Entitlements are a mechanism for publishers to better ensure that their content is only being distributed to and accessible by “qualified clients.” Individuals, through a vendor's distribution channel, can only get access to a publisher's content if that publisher has explicitly acknowledged to the vendor that the individual is permitted to access that set of content. The granting of entitlements is typically at the complete discretion of the publisher.

As vendor platforms have become more robust and useful to the publishers' clients, clients have insisted on a greater breadth and depth of content to be redistributed to the vendor community from the publishers. As time has passed, more content has been distributed to more clients through more vendors causing a significant burden on vendors and publishers to manage entitlements efficiently. This burden continues to grow today as the entitlement processes, capabilities, and tools vary greatly from vendor to vendor and publishers struggle to service their clients' content needs while not risking their company's intellectual property.

It is therefore desirable to provide improved methods, media, and systems for entitlement clearing.

### SUMMARY

In accordance with the disclosed subject matter, methods, media, and systems for entitlement clearing are provided. In some embodiments, methods for entitlement clearing are provided including receiving a first entitlement request from a first vendor and a second entitlement request from a second vendor, determining the status of the first entitlement request and the status of the second entitlement request, and sending a first entitlement response to the first vendor and a second entitlement response to the second vendor.

In some embodiments, computer-readable media containing computer-executable instructions that, when executed by a processor, cause the processor to perform methods for entitlement clearing. The methods including receiving a first entitlement request from a first vendor and a second entitlement request from a second vendor, determining the status of the first entitlement request and the status of the second entitlement request, and sending a first entitlement response to the first vendor and a second entitlement response to the second vendor.

In some embodiments, systems for entitlement clearing are provided including a first interface that receives a first entitlement request from a first vendor and a second entitlement request from a second vendor, a processor that determines the status of the first entitlement request and the status of the second entitlement request, and a second interface that sends a first entitlement response to the first vendor and a second entitlement response to the second vendor.

### BRIEF DESCRIPTION OF THE DRAWINGS

FIG. 1 is a block diagram showing flow of entitlement requests and entitlement responses between vendors, an entitlement system, and publishers in accordance with some embodiments.

FIG. 2 is an illustration of a user interface for an entitlement request search screen in accordance with some embodiments.

FIG. 3 is an illustration of another user interface for an entitlement request search screen in accordance with some embodiments.

FIG. 4 is an illustration of a user interface for confirmation screen in accordance with some embodiments.

FIG. 5 is an illustration of a user interface for a user search screen in accordance with some embodiments.

FIG. 6 is an illustration of a sample XML document in accordance with some embodiments.

### DETAILED DESCRIPTION

In accordance with various embodiments of the disclosed subject matter, methods, media, and systems for entitlement clearing are provided. These methods, media, and systems provide mechanisms through which entitlement information can be conveyed between publishers and vendors. For example, a publisher, such as Goldman Sachs, may desire to allow certain of its clients to access financial research on TheMarkets.com website, which is an example of a vendor. In order to convey information about the entitlements of these certain clients, Goldman Sachs may communicate through these mechanisms.

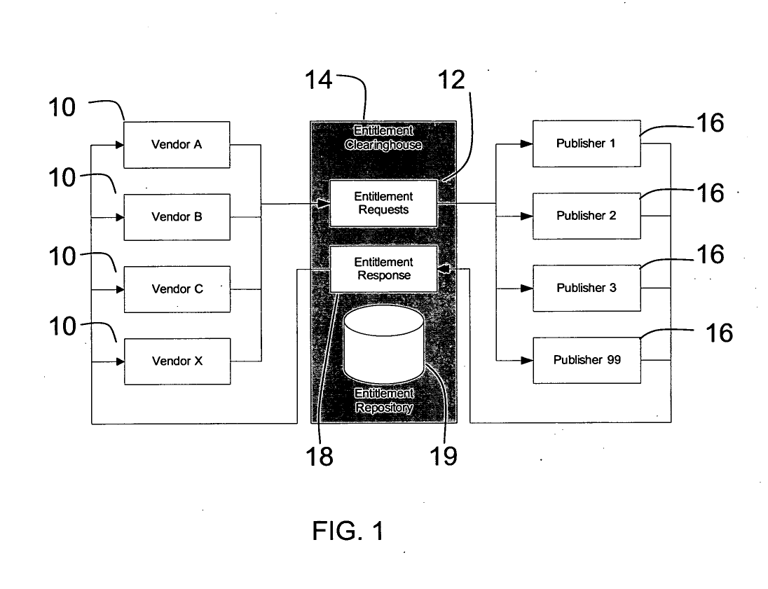

FIG. 1 shows an example of high level interactions between vendors and publishers and the high level work flow of entitlement clearing enabled by various embodiments.

As shown, vendors 10 on the left may submit entitlement requests 12 to an entitlement system 14 in the center. Each entitlement request may be caused by a client (not shown) attempting to access content through a vendor's Web page (not shown), or other distribution channel. Entitlement system 14 may then process these requests 12 and send them to the appropriate publishers 16, on the right. Publishers 16 may then process the requests, e.g., by comparing each request to a list of authorized clients (not shown), and respond by issuing an entitlement response 18 that is sent back to entitlement system 14. The entitlement system may then send response 18 to vendors 10.

In certain instances, entitlement system 14 may respond to some requests 12 from vendors 10 without forwarding the requests to publishers 16. For example, a request from a vendor may be sent to the entitlement system and processed by referring to an entitlement repository 19, where previous entitlement data from a corresponding vendor has been stored. In order to facilitate such activity, the entitlement system may store requests, responses, and/or any other suitable data in one or more entitlement repositories, which may be any suitable mechanism, such as a database, for storing data.

In order to provide security, entitlement system 14 may use the Direct Authentication pattern in some embodiments. In some embodiments, the Direct Authentication pattern operates by a request first coming from a client to a service. The credentials in the request are then validated using an identity store (which may be any suitable form of data storage) by the service. And then a response (e.g., approved or denied) is provided from the service to the client. This pattern is detailed in the following references which are hereby incorporated by reference herein in their entireties: Web Service Security: Scenarios, Patterns, and Implementation Guidance for Web Services Enhancements (WSE) 3.0—Microsoft Patterns & Practices Group, Microsoft Corporation; SOAP Message Security 1.0 (WS-Security 2004)—OASIS Open (http://www.oasis-open.org); UsernameToken Profile 1.0—OASIS Open; and Protect Your Web Services Through the Extensible Policy Framework in WSE 3.0—Tomasz Janczuk, MSDN Magazine, from Microsoft Corporation (http://msdn.microsoft.com//msdnmag/issues/06/02/wse30/default.aspx).

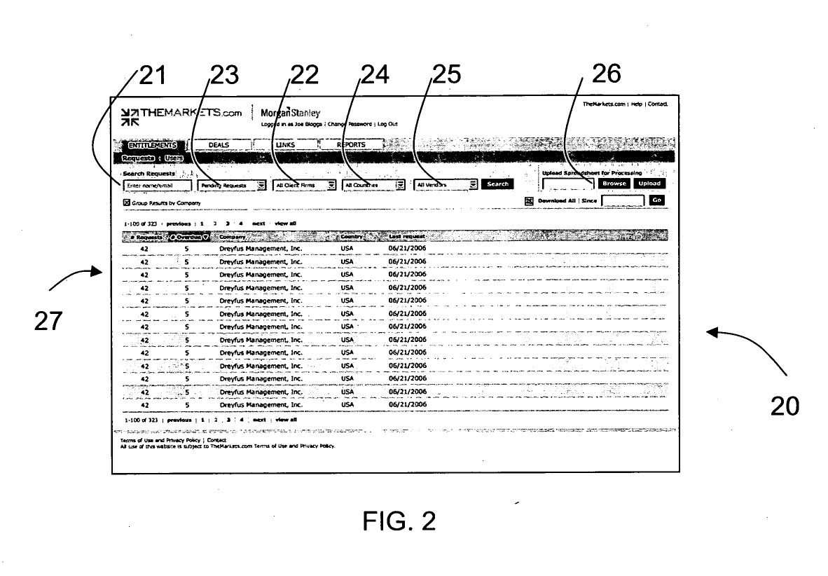

In some embodiments, the entitlement system may use graphical user interfaces that may be presented through Web pages or any other suitable mechanisms. Examples of user interfaces that may be utilized are discussed below and provided in FIGS. 2-5. As will be apparent, other user interfaces may additionally or alternatively be used.

FIG. 2 illustrates and example of an entitlement request search screen 20, wherein entitlement requests are grouped by client firm. This screen allows the publisher to search for entitlement requests that have been submitted to the publisher from any vendor. This screen is grouped by client firm to allow the publisher to quickly highlight which client firm may need their immediate attention. Using the screen, a publisher may search for requests of a certain client firm by entering the firm's name in field 21. Using fields 22, 23, 24, and 25, the publisher can filter the types of requests to be displayed (e.g., pending, approved, or rejected), select client firm names from a list, filter requests by country, and filter requests by vendor, respectively. As shown in region 27, the screen may reflect the number of requests, the number of days (or other suitable period of time) that processing of those requests is overdue, the client firm name, the country associated with those requests and the most-recent date of those requests.

As also shown in FIG. 2, a spreadsheet with user information in it can be uploaded into the entitlement system to simplify data entry using interface 26. Such a spreadsheet can come from any suitable source, such as a publisher.

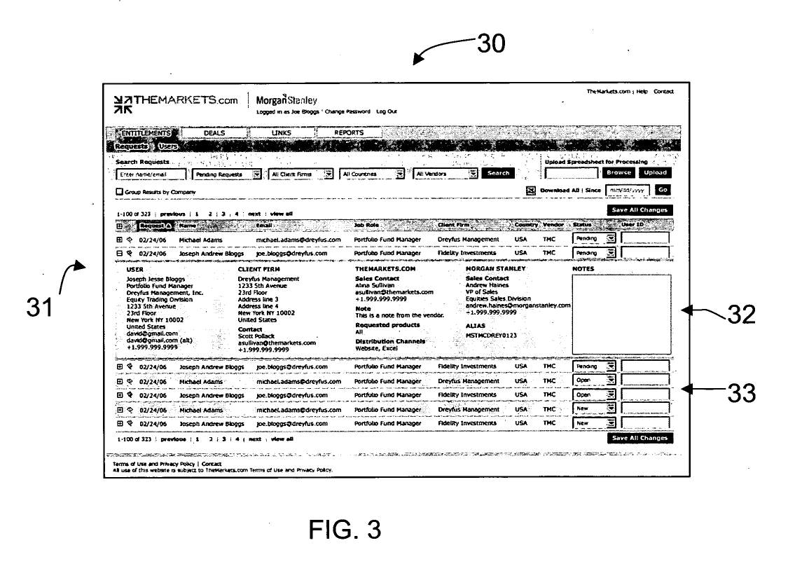

FIG. 3 illustrates an example of an entitlement request search screen 30, wherein entitlement requests are not grouped by client firm. This screen allows a publisher to search for entitlement requests that have been submitted to the publisher from any vendor. From the screen the publisher can process (e.g., approve or reject) any request, regardless of vendor, or update various attributes of the requests (e.g. status or notes) to manage workflow. As shown in FIG. 3, a region 31 may include rows 32 and 33. A row 32 can include contact information for a user (which may include job role and division), contact information for a company, contact information at the vendor, a field for a note from the vendor, a list of requested products, a list of distribution channels, publisher contact information, an alias for a user, a field for entering notes by the publisher, and/or any other suitable information. A row 33 can include a request date, a user name, an email address for the user, a job role, a client firm company name, a country for the user, a vendor name, a status field (e.g., for new, pending, open, accepted, rejected, etc.), and a user identifier that can be entered by the publisher, and/or any other suitable information.

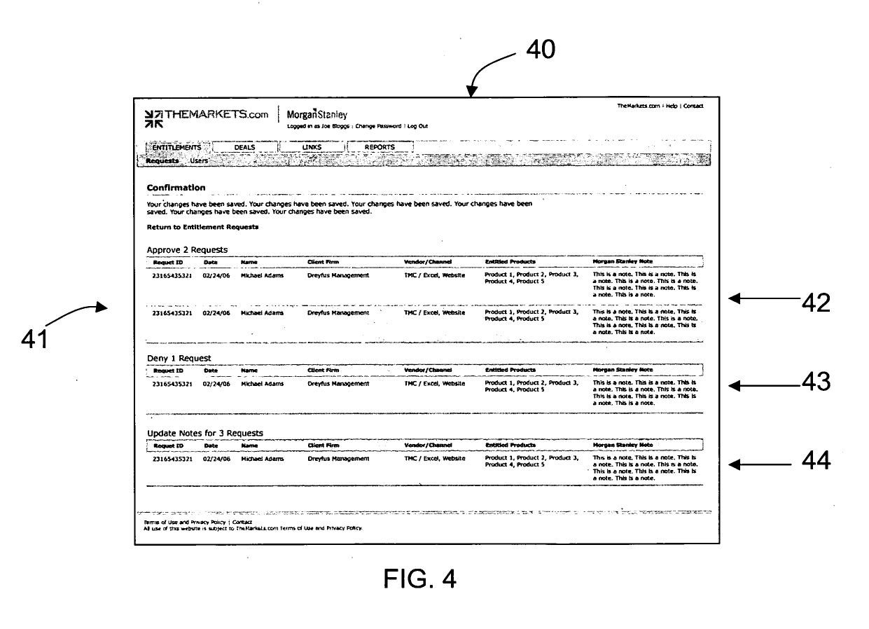

FIG. 4 illustrates an example of a confirmation screen 40. This screen illustrates to a publisher the actions taken on a given set of entitlement requests. As shown, different sections 42, 43, and 44 may be included in a region 41. Section 42 may indicate requests that have been approved, and includes a count of such requests, and rows for each such request. Section 43 may indicate requests that have been denied, and includes a count of such requests, and rows for each such request. Section 44 may indicate requests that have been updated, and includes a count of such requests, and rows for each such request. The rows in sections 42, 43, and 44 may include a request identifier, a request date, a user name, a client firm company name, a vendor name and list of distribution channels, a list of products, publisher notes, and/or any other suitable information.

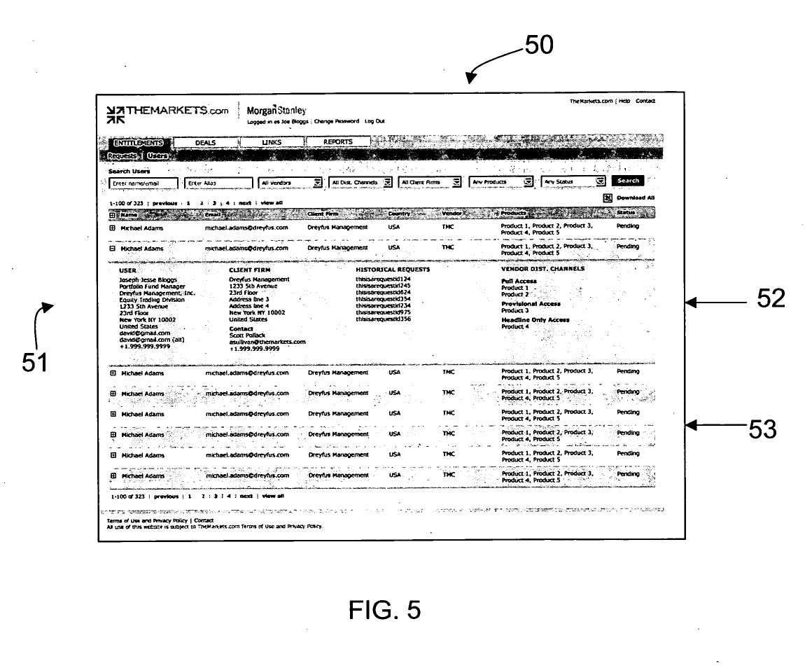

FIG. 5 illustrates an example of a user search screen 50. This screen allows the publisher to search through the entitlement data repository for all users that have requested access from that publisher. The results returned allow a contributor to understand what users have access to what content on which vendor distribution channel. As shown, a region 51 may include rows 52 and 53. A row 52 may include user contact information (which may include job role and division), client firm contact information, vendor contact information, a list of historical requests, a list of vendor distribution channels (which may be divided into regions for different levels of access, such as full access, provisional access, headline-only access, and/or any other suitable forms of access). A row 53 may include a user name, an email address, a client firm company name, a country, a vendor name, a list of products, and a status indicator (e.g., pending, approved, rejected, new, or open), and/or any other suitable information.

In accordance with some embodiments, an application programming interface (API) may be provided between a vendor and the entitlement system. This API may allow the vendor to create a user entry, to update a user entry, to create a user company entry, to update a user company entry, to submit an entitlement request, to update an entitlement request, to cancel an entitlement request, to get an entitlement request, to get a user entry, to get contributor product information, and to receive entitlement information.

To create a user entry, in some embodiments, the vendor may send an XML document to the entitlement system. This document may include: a timestamp; an identifier for the user generated by the vendor; an identifier of a type or category associated with the identifier for the user; one or more email addresses of the user; an address of the user; a job role associated with the user; a division associated with the user; and/or one or more names associated with the user. In response to this document, the entitlement system may generate a return XML document containing an identifier for the user generated by the entitlement system. Prior to generating the return document, the entitlement system may check the validity of the information provided by the vendor. Such validation may be performed using any suitable technique. An error may be generated if the validation fails.

To update a user entry, in some embodiments, the vendor may send an XML document to the entitlement system. This document may include the identifier for the user generated by the entitlement system and/or the same information, or a subset thereof, in the document for creating a user entry. In response to this document, the entitlement system may generate a return XML document containing an identifier for the user generated by the entitlement system. Prior to generating the return document, the entitlement system may check the validity of the information provided by the vendor. Such validation may be performed using any suitable technique. An error may be generated if the validation fails, the entitlement system user identifier cannot be found, and/or if the user identifier generated by the entitlement system and the user identifier generated by the vendor have changed from when the user entry was created.

To create a user company entry, in some embodiments, the vendor may send an XML document to the entitlement system. This document may include: a timestamp; a identifier for the company generated by the vendor; a name associated with the company; and/or an address associated with the company. In response to this document, the entitlement system may generate a return XML document containing an identifier for the company generated by the entitlement system. Prior to generating the return document, the entitlement system may check the validity of the information provided by the vendor. Such validation may be performed using any suitable technique. An error may be generated if the validation fails.

To update a user company entry, in some embodiments, the vendor may send an XML document to the entitlement system. This document may include the identifier for the company generated by the entitlement system and/or the same information, or a subset thereof, in the document for creating a company entry. In response to this document, the entitlement system may generate a return XML document containing an identifier for the company generated by the entitlement system. Prior to generating the return document, the entitlement system may check the validity of the information provided by the vendor. Such validation may be performed using any suitable technique. An error may be generated if the validation fails and/or the entitlement system company identifier cannot be found.

To submit an entitlement request, in some embodiments, the vendor may send an XML document to the entitlement system. This document may include: a timestamp; vendor data that may be tied to the request and passed back with a response; a user identifier generated by the entitlement system for the user; a company identifier generated by the entitlement system for the user's company; contact information for the user's company (e.g., a contact identifier, name, email address, physical address, and phone number); vendor sales representative information (e.g., a sales representative identifier, name, email address, physical address, and phone number); a publisher identifier (that may be assigned by the entitlement system); publisher sales representative information (e.g., contact email address, job role, division, telephone number, and name) that may be used to validate the user's relationship with the publisher; comments associated with the request; a list of one or more products requested by the user; and a list of one or more vendor distribution channels that may be used to distribute the content. In response to this document, the entitlement system may generate a return XML document containing a request identifier and the vendor data. Prior to generating the return document, the entitlement system may check the validity of the information provided by the vendor. Such validation may be performed using any suitable technique. An error may be generated if the validation fails, if a pending request for the user, vendor, and contributor combination already exists, if the vendor does not have permission to make the request, the user cannot be found based on the user identifier, and/or the company cannot be found based on the company identifier.

To update an entitlement request, in some embodiments, the vendor may send an XML document to the entitlement system. This document may include the request identifier returned in response to the entitlement request, a reminder that the request is past due, and/or the same information, or a subset thereof, provided in the entitlement request. In response to this document, the entitlement system may generate a return XML document containing a request identifier and the vendor data. Prior to generating the return document, the entitlement system may check the validity of the information provided by the vendor. Such validation may be performed using any suitable technique. An error may be generated if the validation fails, if the request to be updated does not exist, the vendor does not have permission to update the request, and/or the user identifier cannot be changed.

To cancel an entitlement request, in some embodiments, the vendor may send an XML document to the entitlement system. This document may include a timestamp and/or request identifier. In response to this document, the entitlement system may generate a return XML document containing the request identifier. Prior to generating the return document, the entitlement system may check the validity of the information provided by the vendor. Such validation may be performed using any suitable technique. An error may be generated if the validation fails, if the request to be cancelled does not exist, if the request is not pending, and/or if the vendor does not have permission to cancel the request. In some embodiments, only requests that are pending can be cancelled.

To get an entitlement request, in some embodiments, the vendor may send an XML document to the entitlement system. This document may include: a timestamp; a request identifier; and/or a request type (e.g., a specific entitlement request, only pending entitlement requests, only pending entitlement requests that were submitted since the last request to get an entitlement request, or all historical entitlement requests, regardless of status). In response to this document, the entitlement system may generate a return XML document containing a collection of entitlement request objects. Each entitlement request object may contain: a request identifier; a timestamp; vendor data; a user identifier generated by the entitlement system for the user; a user identifier generated by the vendor; an identifier of the category or type of user identifier generated by the vendor; contact information for the user (e.g., a user name, email address, physical address, job role, division, and phone number); a company identifier generated by the vendor; contact information for the company (e.g., name, address, and phone number); vendor sales representative information (e.g., a sales representative identifier, name, email address, physical address, and phone number); a publisher identifier (that may be assigned by the entitlement system); publisher sales representative information (e.g., contact email address, job role, division, telephone number, and name) that may be used to validate the user's relationship with the publisher; comments associated with the request; a list of one or more products requested by the user; a list of one or more vendor distribution channels that may be used to distribute the content; a reminder that this request is past due; and status information (e.g., approved, pending, rejected, or cancelled). Prior to generating the return document, the entitlement system may check the validity of the information provided by the vendor. Such validation may be performed using any suitable technique.

To get a user entry, in some embodiments, the vendor may send an XML document to the entitlement system. This document may include: a timestamp; a user identifier generated by the entitlement system; and/or a user identifier generated by the vendor. In response to this document, the entitlement system may generate a return XML document containing one or more user objects. These user objects may include: a user identifier generated by the entitlement system; a user identifier generated by the vendor; an identifier of the category or type of user identifier generated by the vendor; contact information for the user (e.g., a user name, email address, physical address, job role, division, and phone number); a company identifier generated by the vendor; contact information for the company (e.g., name, address, and phone number); a list of one or more historical entitlement requests (e.g., a list of the identifiers of the requests); and/or a list of one or more vendor distribution channels (e.g., for each channel, an identifier for the channel, and a list of products for each channel (e.g., a product identifier, a flag indicating whether only the headline of the product may be displayed, a flag indicating whether provisional access to the product has been granted, and/or an indicator of the status of the user's access to the product). Prior to generating the return document, the entitlement system may check the validity of the information provided by the vendor. Such validation may be performed using any suitable technique. In some embodiments, entitlement information may be retrieved for a defined user, a set of users, or all users.

To get contributor product information, in some embodiments, the vendor may send an XML document to the entitlement system. This document may include an identifier of the publisher generated by the entitlement system. In some embodiments, a special identifier (e.g., NULL) may be used to identify all publishers. In response to this document, the entitlement system may generate a return XML document containing: an identifier for the publisher generated by the entitlement system; a name for the publisher; a list of one or more vendor distribution channels (e.g., for each channel, an identifier for the channel, and a list of products for each channel (e.g., a product identifier, a product description, a flag indicating whether only the headline of the product may be displayed, and/or a flag indicating whether provisional access to the product has been granted). Prior to generating the return document, the entitlement system may check the validity of the information provided by the vendor. Such validation may be performed using any suitable technique. An error may be generated if the validation fails, and/or if the requested publisher's products are not available.

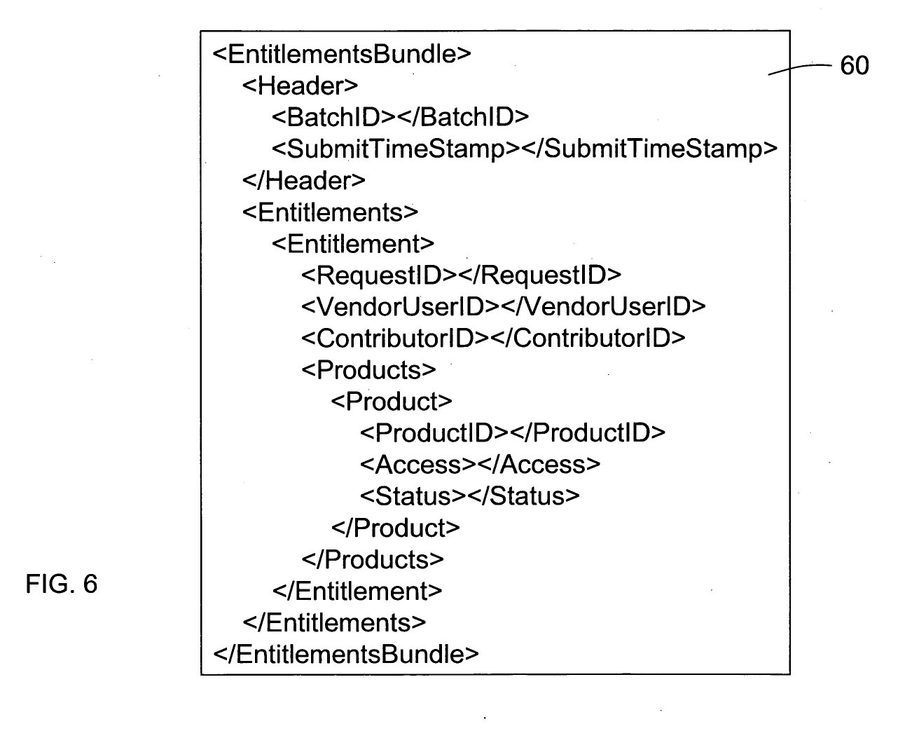

Entitlements may be sent to a vendor using a vendor-supplied API. This API may be implemented in the form of a SOAP-based web service that can accept a single parameter of XML document in some embodiments. An example of an XML document is shown in FIG. 6.

In accordance with some embodiments, an application programming interface (API) may be provided between a publisher and the entitlement system. This API may allow the publisher to get entitlement requests, to set user entitlements, to get entitlements for a user, and to get publisher product information.

To get an entitlement request, in some embodiments, the vendor may send an XML document to the entitlement system. This document may include: a timestamp; a request identifier; and/or a request type (e.g., a specific entitlement request, only pending entitlement requests, only pending entitlement requests that were submitted since the last request to get an entitlement request, or all historical entitlement requests, regardless of status). In response to this document, the entitlement system may generate a return XML document containing a collection of entitlement request objects. Each entitlement request object may contain: a request identifier; a timestamp; an identifier of the vendor; a user identifier generated by the entitlement system for the user; a user identifier generated by the vendor; an identifier of the category or type of user identifier generated by the vendor; an alias for the user that is shared between the entitlement system and the publisher, contact information for the user (e.g., a user name, email address, physical address, job role, division, and phone number); a company identifier generated by the vendor; contact information for the company (e.g., name, address, phone number, and identifiers and contact information for people in the company (e.g., name, email address, and phone number); vendor sales representative information (e.g., a sales representative identifier, name, email address, physical address, and phone number); a publisher identifier (that may be assigned by the entitlement system); publisher sales representative information (e.g., contact email address, job role, division, telephone number, and nane) that may be used to validate the user's relationship with the publisher; comments associated with the request; a list of one or more products requested by the user; a list of one or more vendor distribution channels that may be used to distribute the content; a reminder that this request is past due; and status information (e.g., approved, pending, rejected, or cancelled). Prior to generating the return document, the entitlement system may check the validity of the information provided by the vendor. Such validation may be performed using any suitable technique.

To set user entitlements, in some embodiments, the vendor may send an XML document to the entitlement system. This document may include: a request identifier; a note from the publisher to the vendor regarding the action taken (e.g., why the user was rejected); an alias for the user shared by the entitlement system and the publisher; and/or a list of product identifiers of products to which the user is entitled access. In response to this document, the entitlement system may generate a return XML document containing: an identifier for the user generated by the entitlement system; the alias; an identifier for the vendor; a vendor distribution channel identifier identifying where the product will be available to the user; information for products to be made available to the user (e.g., product identifier, a flag indicating whether only the headline of the product may be displayed, a flag indicated whether access to the product has been granted by default, and/or information regarding the status of the user's access to the product); and/or an identifier for the request. Prior to generating the return document, the entitlement system may check the validity of the information provided by the vendor. Such validation may be performed using any suitable technique. An error may be generated if the validation fails.

To get a user entry, in some embodiments, the vendor may send an XML document to the entitlement system. This document may include: a user identifier generated by the entitlement system; an alias for the user shared by the entitlement system and the publisher; a vendor identifier; a vendor distribution channel identifier identifying where the products will be available to the user; an identifier of the company of the user; the name of the company of the user; information regarding the status of the user with respect to the publisher (e.g., approved, rejected, or pending); a flag indicating whether the user is associated with a pending entitlement request (e.g., so that the user might be approved or rejected but still subject to a subsequent entitlement decision); and/or an identifier of one or more products to which the user is entitled access. In response to this document, the entitlement system may generate a return XML document containing one or more user objects. These user objects may include: a user identifier generated by the entitlement system; a user identifier generated by the vendor; an alias for the user; a vendor identifier; an identifier generated by the vendor for the user; an identifier of the category or type of user identifier generated by the vendor; contact information for the user (e.g., a user name, email address, physical address, job role, division, and phone number); a company identifier generated by the vendor; contact information for the company (e.g., name, address, and phone number); a list of one or more historical entitlement requests (e.g., a list of the identifiers of the requests); and/or a list of one or more vendor distribution channels (e.g., for each channel, an identifier for the channel, and a list of products for each channel (e.g., a product identifier, a flag indicating whether only the headline of the product may be displayed, a flag indicating whether provisional access to the product has been granted, and/or an indicator of the status of the user's access to the product). Prior to generating the return document, the entitlement system may check the validity of the information provided by the vendor. Such validation may be performed using any suitable technique. In some embodiments, entitlement information may be retrieved for a defined user, a set of users, or all users.

To get publisher product information, in some embodiments, the vendor may send an XML document to the entitlement system. In response to this document, the entitlement system may generate a return XML document containing a list of vendor identifiers, each listing of vendors including a list of vendor distribution channels for the corresponding vendor, and for each channel, a list of products available on that channel, including a product identifier, a product description, a flag indicating whether only the headline of the product may be displayed, a flag indicating whether provisional access to the product has been granted, and an indicator of the amount of time that must pass after the last time a user was rejected before provisional access can be provided. Prior to generating the return document, the entitlement system may check the validity of the information provided by the vendor. Such validation may be performed using any suitable technique. An error may be generated if the validation fails and/or if the requested information is not accessible to the vendor.

Although the invention has been described and illustrated in the foregoing illustrative embodiments, it is understood that the present disclosure has been made only by way of example, and that numerous changes in the details of implementation of the invention can be made without departing from the spirit and scope of the invention, which is only limited by the claims which follow. Features of the disclosed embodiments can be combined and rearranged in various ways.

What is claimed is:

1. A method for entitlement clearing comprising:
receiving a first entitlement request from a first vendor and a second entitlement request from a second vendor;
determining the status of the first entitlement request and the status of the second entitlement request; and
sending a first entitlement response to the first vendor and a second entitlement response to the second vendor.

2. The method of claim 1, further comprising:
sending at least a portion of the first entitlement request to a first publisher, and at least a portion of the second entitlement request to a second publisher;
receiving a first publisher response to the at least a portion of the first entitlement request, and a second publisher response to the at least a portion of the second entitlement request; and
using the first publisher response to determine the status of the first entitlement request, and the second publisher response to determine the status of the second entitlement request.

3. The method of claim 1, further comprising using an entitlement repository to determine the status of the first entitlement request and to determine the status of the second entitlement request.

4. The method of claim 1, wherein the status includes pending, approved, and rejected.

5. The method of claim 1, wherein the first entitlement request and the second entitlement request are each to determine whether one or more users may have access to content.

6. The method of claim 5, wherein the content are financial analysis reports.

7. The method of claim 1, wherein the first entitlement request and the second entitlement request are in the form of XML documents.

8. A computer-readable medium containing computer-executable instructions that, when executed by a processor, cause the processor to perform a method for entitlement clearing, the method comprising:
receiving a first entitlement request from a first vendor and a second entitlement request from a second vendor;
determining the status of the first entitlement request and the status of the second entitlement request; and
sending a first entitlement response to the first vendor and a second entitlement response to the second vendor.

9. The medium of claim 8, wherein the method further comprises:
sending at least a portion of the first entitlement request to a first publisher, and at least a portion of the second entitlement request to a second publisher;
receiving a first publisher response to the at least a portion of the first entitlement request, and a second publisher response to the at least a portion of the second entitlement request; and
using the first publisher response to determine the status of the first entitlement request, and the second publisher response to determine the status of the second entitlement request.

10. The medium of claim 8, wherein the method further comprises using an entitlement repository to determine the status of the first entitlement request and to determine the status of the second entitlement request.

11. The medium of claim 8, wherein the status includes pending, approved, and rejected.

12. The medium of claim 8, wherein the first entitlement request and the second entitlement request are each to determine whether one or more users may have access to content.

13. The medium of claim 12, wherein the content are financial analysis reports.

14. The medium of claim 8, wherein the first entitlement request and the second entitlement request are in the form of XML documents.

15. A system for entitlement clearing comprising:
a first interface that receives a first entitlement request from a first vendor and a second entitlement request from a second vendor;
a processor that determines the status of the first entitlement request and the status of the second entitlement request; and
a second interface that sends a first entitlement response to the first vendor and a second entitlement response to the second vendor.

16. The system of claim 15, further comprising:
a third interface that sends at least a portion of the first entitlement request to a first publisher, and at least a portion of the second entitlement request to a second publisher; and
a fourth interface that receives a first publisher response to the at least a portion of the first entitlement request, and a second publisher response to the at least a portion of the second entitlement request,
wherein the processor also uses the first publisher response to determine the status of the first entitlement request, and the second publisher response to determine the status of the second entitlement request.

17. The system of claim 15, wherein the processor also uses an entitlement repository to determine the status of the first entitlement request and to determine the status of the second entitlement request.

18. The system of claim 15, wherein the status includes pending, approved, and rejected.

19. The system of claim 15, wherein the first entitlement request and the second entitlement request are each to determine whether one or more users may have access to content.

20. The system of claim 19, wherein the content are financial analysis reports.

21. The system of claim 15, wherein the first entitlement request and the second entitlement request are in the form of XML documents.
